(19) United States
(12) Patent Application Publication
(10) Pub. No.: US 2004/0143542 A1
(43) Pub. Date: Jul. 22, 2004

(54) System and method for interactive electronic open order book for securities transactions

(76) Inventors: Louis Magill, Winter Park, FL (US); Bob Semones, Winter Park, FL (US)

Correspondence Address: David I. Roche, BAKER & McKENZIE, 130 E. Randolph Drive, Chicago, IL, 60601, US

(21) Appl. No.: 10/752,419

(22) Filed: Jan. 5, 2004

Related U.S. Application Data
(63) Continuation of application No. 09/609,028, filed on Jun. 30, 2000, now abandoned.
(60) Provisional application No. 60/141,859, filed on Jul. 1, 1999.
(60) Provisional application No. 60/155,489, filed on Sep. 23, 1999.

(51) Int. Cl. G06F 17/60

(52) U.S. Cl. 705/37; 705/36

(57) ABSTRACT

A method and system for trading securities and other goods and services is disclosed which incorporates an automated securities trading system for displaying an interactive open order book for matching buyer bids to seller offers, for generating a web page which displays an open order book to a securities buyer or securities seller. The interactive open order book contains data describing a plurality of current bid prices and a plurality of current ask prices of a specified security and an identification of the security.

This is a Continuation Application based on U.S. patent application Ser. No. 09/609,028 filed Jun. 30, 2000, now abandoned.

This application claims the benefit of Provisional Application 60/141,859, filed Jul. 1, 1999, and Provisional Application 60/155,489, filed Sep. 23, 1999, the entire disclosures of which are incorporated herein by reference. This application is related to U.S. Application entitled “Method and Apparatus for Processing Securities Transactions” by inventors Louis Magill and Bob Semones filed Jun. 30, 2000 and U.S. Patent Application entitled “System and Method for Match and Range Securities Transaction Orders” by inventors Louis Magill and Bob Semones filed Jun. 30, 2000, which are incorporated herein by reference.

### TECHNICAL FIELD

The present invention relates to a securities trading method and system, and in particular to an improved computer automated securities trading system.

### BACKGROUND OF THE INVENTION

The buying, selling, or trading of securities such as stocks, options, futures, commodities is conducted through a broker or brokerage firm. The brokers or brokerage firms either deal directly with a security exchange, such as the National Association of Security Dealers Automated Quoation (NASDAQ) system, or directly with other brokers or brokerage firms to buy, sell or trade securities.

Individual securities traders must use the services of either a broker or brokerage firm in order to buy, sell or trade their securities. An individual will communicate to his broker or brokerage firm the security they are interested in and the specifics of the buy or sell order. The use of computers and the internet to communicate with one's broker or brokerage firm is well-known.

### SUMMARY OF INVENTION

It is an object of the invention to provide an improved securities trading system.

A further object of the present invention is to provide a securities trading system which includes an Interactive Open Order Book capable of allowing Subscribers via the Internet to aggregate, manipulate, display and interact with the buy and sell order data.

A further object of the present invention is to provide a securities trading system which can trade securities of a given exchange both inside and outside of the traditional trading hours of the given exchange.

In a preferred embodiment, the invention provides an automated securities trading system for displaying an interactive open order book and for matching buyer bids to seller offers which comprises a means for generating a web page which displays an open order book to a securities buyer or securities seller, the open order book comprises data describing a plurality of current bid prices and a plurality of current ask prices of a specified security and an identification of said security.

### BRIEF DESCRIPTION OF DRAWINGS

FIG. 1 is a block diagram of an exemplary hardware environment of the preferred embodiment of the present invention;

FIG. 2 is another block diagram of an exemplary hardware environment of the preferred embodiment of the present invention;

FIG. 3 depicts a screen illustrating the Interactive Order Book;

FIG. 4 depicts a screen illustration the Order Book;

FIG. 5 depicts a screen where a user can preview company and securities related data;

FIG. 6 depicts a screen where a user can obtain summary and historical pricing data of securities;

FIG. 7 depicts a screen where a user can view financial information extracted from SEC filings;

FIG. 8 depicts a screen where a user can view a market summary for all listed companies.

### DETAILED DESCRIPTION

The present invention relates to a system which includes novel software that operates in combination with general purpose computer hardware to provide an electronic auction, matching system or trading system for securities and other goods and services. With regard to the auction, matching or trading of securities, the invention further provides an electronic communications network (ECN), alternative trading system (ATS), or electronic exchange. The system of the invention provides members with the capability of performing auction, matching and trading transactions via the Internet and other available communication mediums. Trading, auction or matching relates to the facilitation of connecting buyers and sellers for the purpose of displaying information and consummating transactions. The term “Subscribers” as used herein includes any type of trading participant in the system, and the term or “the System” as used herein means the system of the invention.

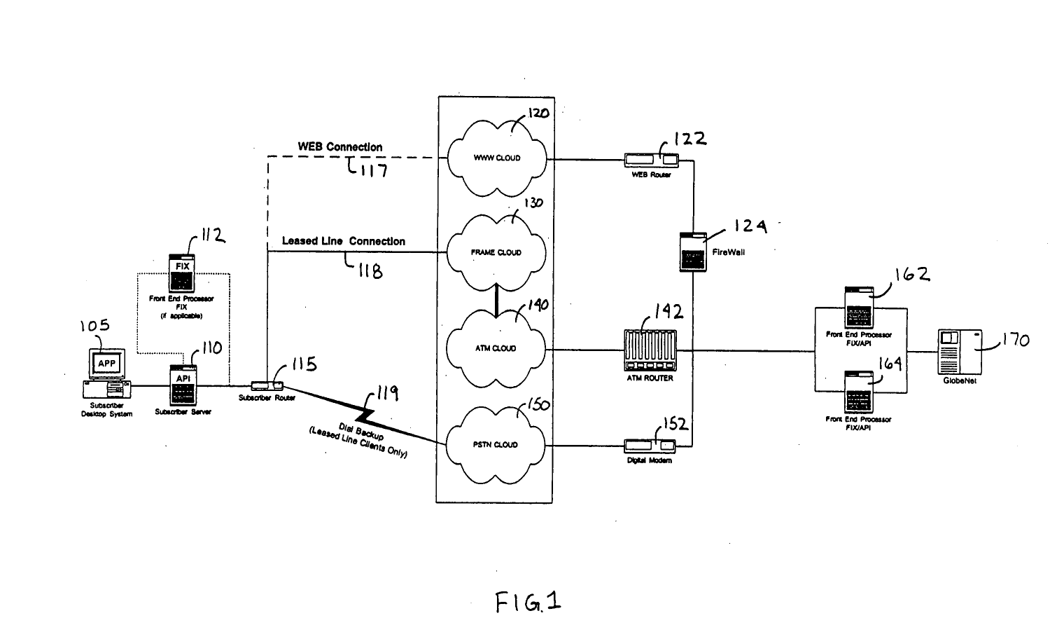

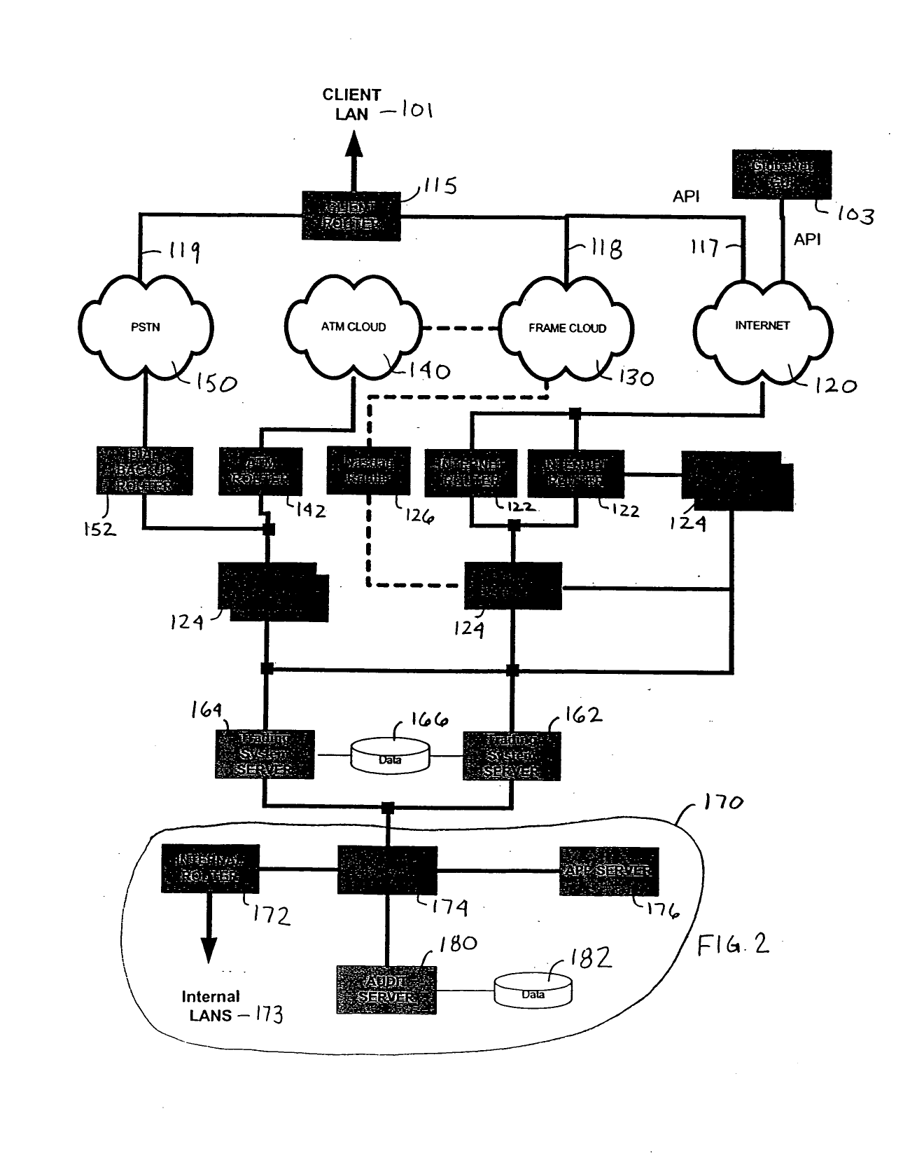

The system configuration, in a preferred embodiment, is discussed with reference to FIGS. 1 and 2. The securities trading system 100 links a Subscriber's desktop unit 105 with the system servers 162, 164 which process securities trading. The Subscriber's desktop unit 105 can be connected to a Subscriber's server 110 or to a front end processor 112. The Subscriber's server 110 would preferably use an Application Program Interface (API) which is a specific communication language and system for the present invention. However, the Subscriber's desktop system 105 may also use a front end processor 112 utilizing a FIX system for connecting through the Internet.

The Subscriber's server 110 or front end processor 112 are then connected to a Subscriber router 115. Based upon the system and communications available the Subscriber router 115 will route the communication from the Subscriber Desktop system 105 to any of three possible paths.

First, if the Subscriber is using an Internet or WEB connection the Subscriber router 115 will direct the communication along the WEB connection 117 to the WEB or Internet which is depicted as the WWW cloud 120. The WWW cloud 120 or Internet connection is then routed by WEB router 122 through a Firewall 124 to the two securities trading servers 162, 164. The securities trading servers 162, 164 are configured to communicate using the API or FIX system. The securities trading servers 162, 164 are also connected to a system administration network 170. Communication from the securities trading servers 162, 164 back to the Subscriber travels along the same path.

Second, provided the Subscriber has a leased line or direct connection the Subscriber router 115 will direct communication through the leased line connection 118 into the attached FRAME cloud 130 and ATM could 140. The FRAME cloud 130 and ATM could 140 convert the communications into an asynchronous transfer mode which structures the exchange into tiny units of information cells. The information cells are then routed by the ATM router 142 to the securities trading servers 162, 164 for processing securities trades. Communication from the securities trading servers 162, 164 back to the Subscriber travels along the same path.

The third communication path which utilizes a phone dial up system is considered more of a backup in the event that the Subscriber can not connect using either their WEB connection 117 or leased line connection 118. In the event that a connection through the WEB connection 117 or leased line connection 118 cannot be made the Subscriber Router 115 will route the communication over a dial backup communication line 119 to a PSTN cloud 150. The PSTN cloud 150 communicates with a digital modem 152 which directs the information to the securities trading servers 162, 164 for processing securities trades. Communication from the securities trading servers 162, 164 back to the Subscriber travels along the same path.

The WEB connection 117, the Leased Line connection 118 and the phone backup connection 119 can each be employed individually or in any combination to provide redundant and backup systems. In a preferred embodiment, a subscriber would have all three systems employed.

As seen in FIG. 2, a client or Subscriber may have their own Local Area Network (LAN) 101 so that multiple users can utilize the system. The Client LAN 101 is connected to the Client/Subscriber router 115 for routing the information through the WEB connection 117, the Leased Line connection 118, or the phone dial backup connection 119. Evident from FIG. 2 is that the WEB connection 117 is connected to the Internet 120 which is connected via Internet routers 122 and multiple Firewalls 124 to the trading system servers 162, 164. The Leased Line connection 118 connects to a FRAME cloud 130 which can connect to the trading system servers 162, 164 in two ways. The FRAME cloud 130 is connected to a market router 126, such as the NASDAQ, which is connected through a Firewall 124 to the trading system servers 162, 164. The FRAME cloud 130 could also be connected to an ATM cloud 140 which converts the information into information cells. An ATM router 140 connects the ATM cloud to the trading system servers 162, 164 after passing through a Firewall 124. The phone dial backup connection 119 connects through the PSTN to a dial backup router/modem 152 which connects the PSTN cloud to the trading system servers 162, 164 after passing through a Firewall 124. Also shown in FIG. 2, is a second Subscriber 103 connected to the system 100 via the WEB or Internet 120.

The trading system servers 162, 164 are configured to allow one server to be the primary server while the other server is used as a backup server. However, the system could be designed to allow both servers to be used concurrently. The trading system servers 162, 164 share a combined data storage 166 and are connected to the system administration network 170.

The system administration network 170 is comprised of an internal router 172, Local Area Network 173, a Firewall 174, an application server 176, an audit server 180, and a data bank 182. Personnel used to administer the system 100 can be connected to one another and the system 100 via a Local Area Network 173 which is connected tot eh Trading System Servers 162, 164 through an internal router 172 and Firewall 174. The Application server 176 is used to run system application and monitoring systems which insure the integrity and functionality of the system 100. The Audit server 180 and the data bank 182 are used in conjunction to both store back-up data and to survey, obtain and provide securities trading market information.

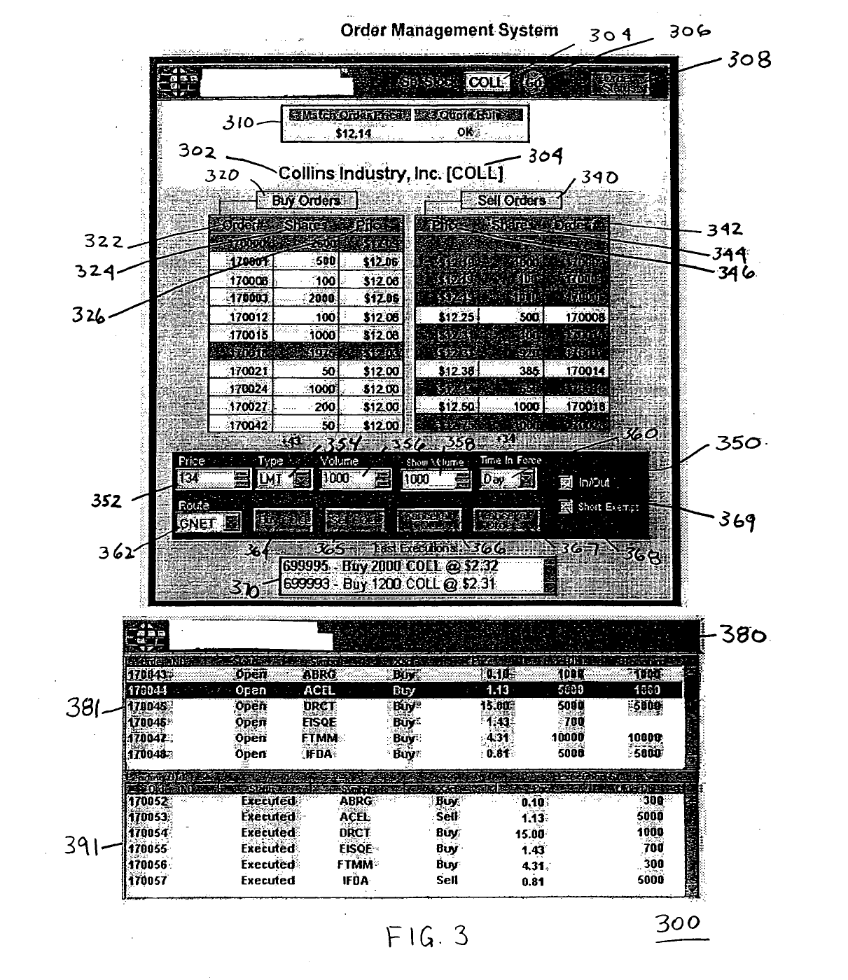

As will be described with reference to FIGS. 3-8, Subscribers interact with the trading servers 162, 164 depicted in FIGS. 1 and 2, through various interactive screens displayed on their desktop system 105.

FIG. 3 depicts a screen containing an Interactive Order Book 300 which may contain the company name 302, the company symbol 304, a company symbol command search button 306, an order status bar 308, a Match Order Price box 310, buy orders 320, and sell orders 340. The buy orders 320 may contain information relating to the order number 322, the number of shares 324 and the price 326. The sell orders 340 may contain information relating to the order number 342, the number of shares 344 and the price 346. The Interactive Order Book 300 may also contain an order window 350 which allows a Subscriber to input a buy or sell order. The order window 350 may contain information relating to price 352, type of order 354, volume 356, show volume 358, time 360, and a route 362. The Subscriber can then click on the Buy button 364, the sell button 365, the cancel all button 366 or the cancel all orders button 367. The Subscriber will also have the option to make the order a short exempt order 368 or an In/Out order 369.

The Interactive Order Book 300 may also contain a last executions window 370 for a specified company and a system transactions window 380. The system transactions window 380 contains real time information for new orders and real time information for executed orders. The system wide new or pending orders are displayed in a pending orders window 381 and the executed orders are displayed in an execution status window 391. In addition, the Subscriber will have the ability to configure the Interactive Order Book 300 to show all of the features described above or to modify the configuration to show only the features desired.

By utilizing the Interactive Order Book 300 a Subscriber can view open buy orders 320, open sell orders 340, the Match Order Price 310, system wide pending orders 381 and the system wide execution status 391 while being able to interact with the system to place or execute orders. The Interactive Order Book 300 serves as a single point of price discovery for securities traded over the system 100 of the present invention. The Interactive Order Book 300 allows the Subscriber to view the most competitively priced, outstanding and unexecuted orders and is an investment tool for price discovery and order tracking. The orders are prioritized on the order book according to price and time.

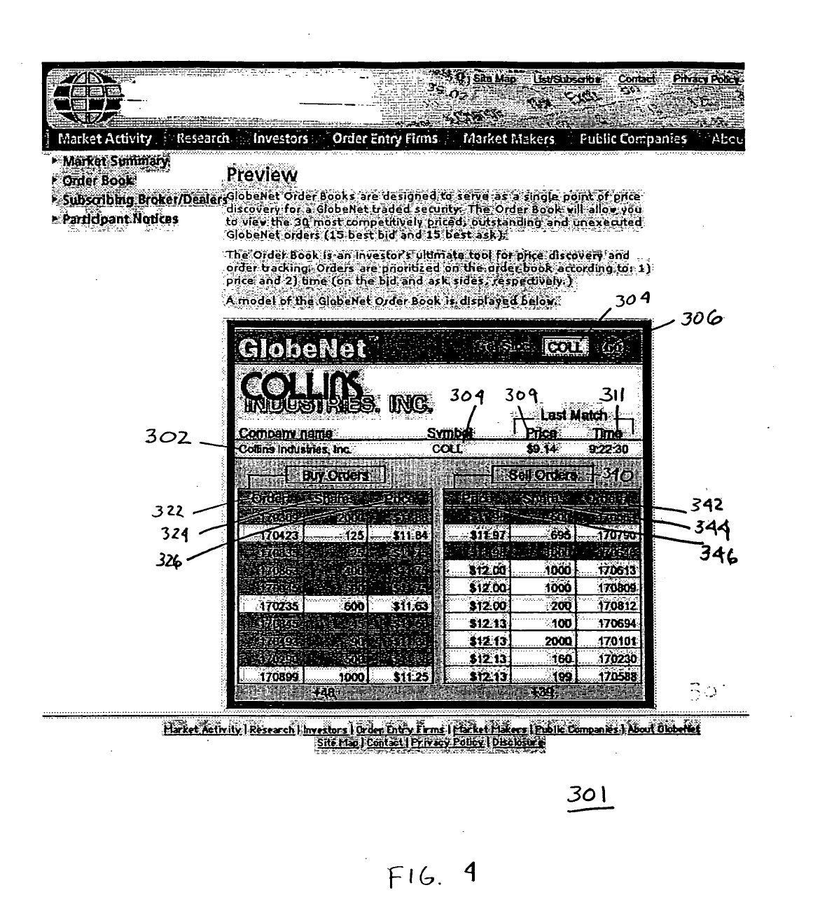

FIG. 4 depicts a screen which contains a non-interactive order book 301. The non-interactive order book 301 contains the same open order information as the interactive order book 300 but does not allow include the order window 350, match order price box 310, last executions window 370, or the systems transaction window 380. The non-interactive order book 301 may contain the company name 302, the company symbol 304, a company symbol command search button 306, Last Match price 309, a Last Match time 311, buy orders 320, and sell orders 340. The buy orders 320 may contain information relating to the order number 322, the number of shares 324 and the price 326. The sell orders 340 may contain information relating to the order number 342, the number of shares 344, and the price 346.

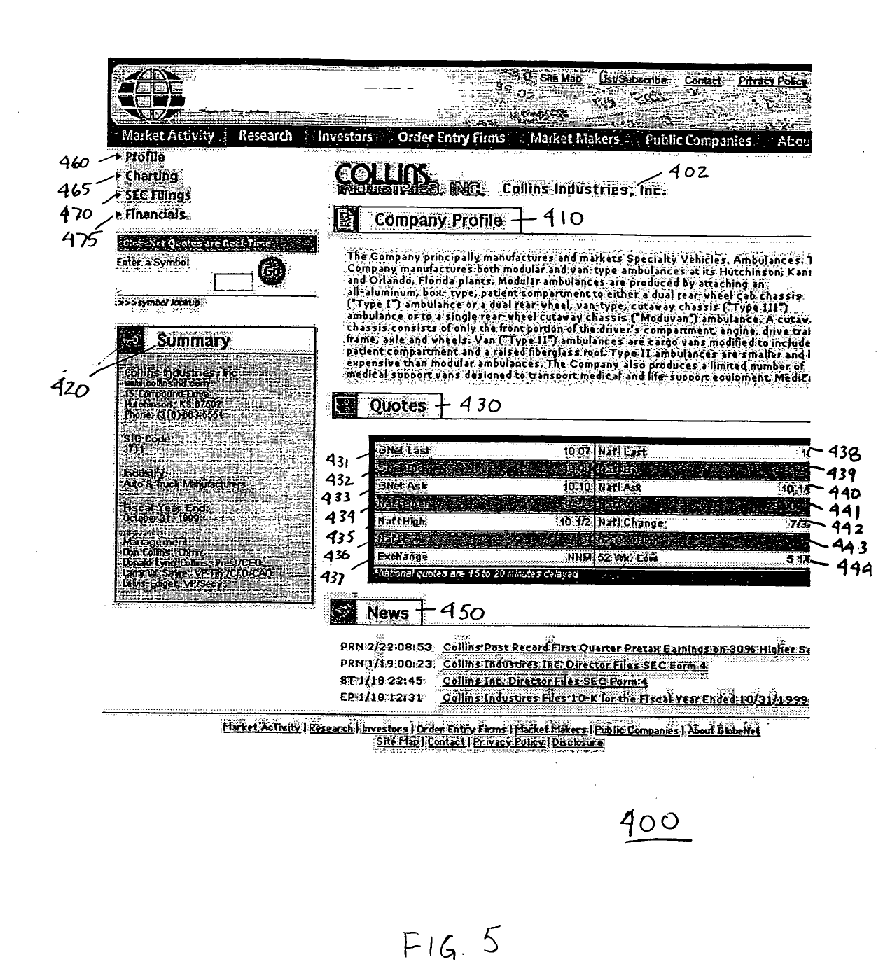

FIG. 5 depicts a screen which contains a company summary profile 400. The company summary profile 400 may contain the company name 102, a company profile 410, a company summary 420, stock quotes 430, and company news 450. The company profile 410 may contain a profile of the company including the type of business or service they provide. The company summary 420 may contain information relating to the company address, company web site, and the officers of the company. The stock quotes 430 contains stock pricing information relating to that company and may include the last system executed transaction 431, the last system bid 432, the last system ask 433, the national open price 434, the national high 435, the national low 436, the exchange the stock is traded on 437, the national last executed transaction 438, the national last bid 439, the national last ask 440, the national volume 441, the national change 442, the 52 week high 443, and the 52 week low 444. The company news 450 may contain links to news stories relating to that company. In addition, the Subscriber will be able to view additional pages through use of the profile summary link 460, the Charting link 465, the SEC filings link 470, or the Financials link 475.

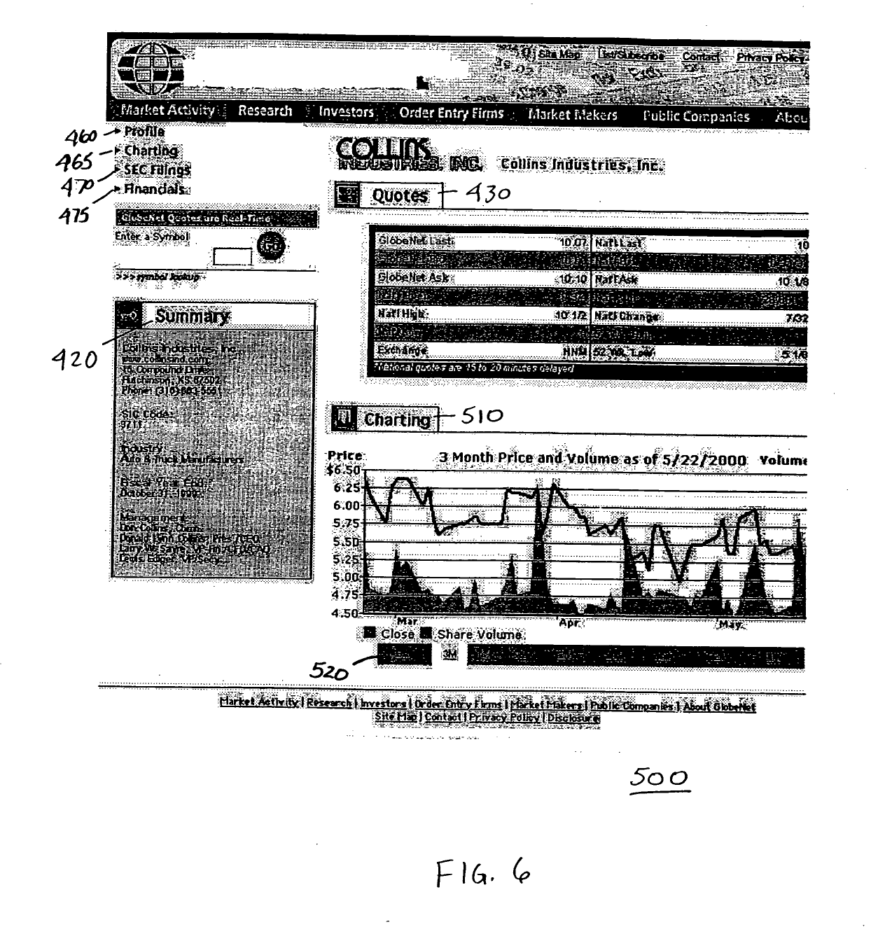

FIG. 6 depicts a screen which contains charting and pricing information 500. Once again the charting and pricing information 500 may contain a company summary 420, stock quotes 430, the profile summary link 460, the Charting link 465, the SEC filings link 470, and the Financials link 475 as described above. Further, the charting and pricing information 500 will contain a charting window 510. The charting window 510 will be able to display charts based with varying time increments by selecting a time increment such as the current trading day, the last 3 months, 6 months, 9 months, 12 months, 24 months, 48 months, 72 months, or 96 months by clicking on the preferred time increment on the time selection bar 520. Further, based upon the time increment chosen the Subscriber can select to chart the daily price changes, the closing price or the share volume.

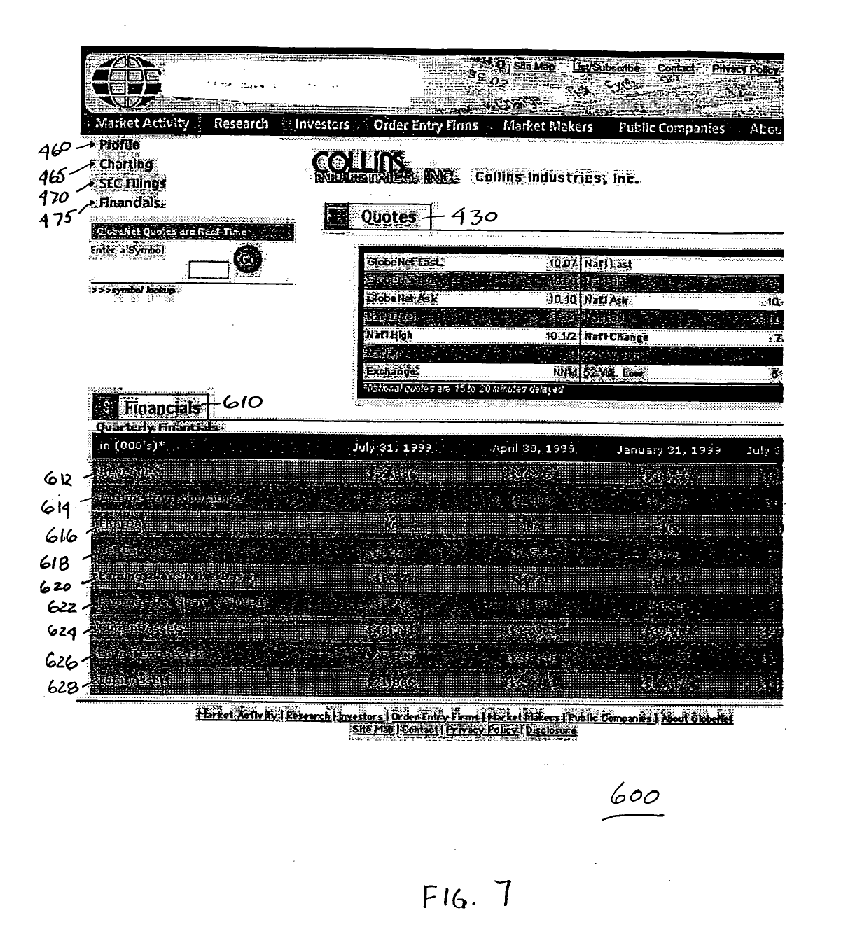

FIG. 7 depicts a screen which contains company financial information 600 which is extracted from Securities Exchange Commission (SEC) filings. Once again the charting and pricing information 500 may contain stock quotes 430, the profile summary link 460, the Charting link 465, the SEC filings link 470, and the Financials link 475 as described above. The company financial information 600 contains a Financial window 610 which may contain information relating to revenues 612, income 614, EBITDA (earnings before interest, tax, depreciation and amortization) 616, net earnings 618, earnings per share 620, earnings per share (diluted) 622, current assets 624, long term assets 626, and total assets 628.

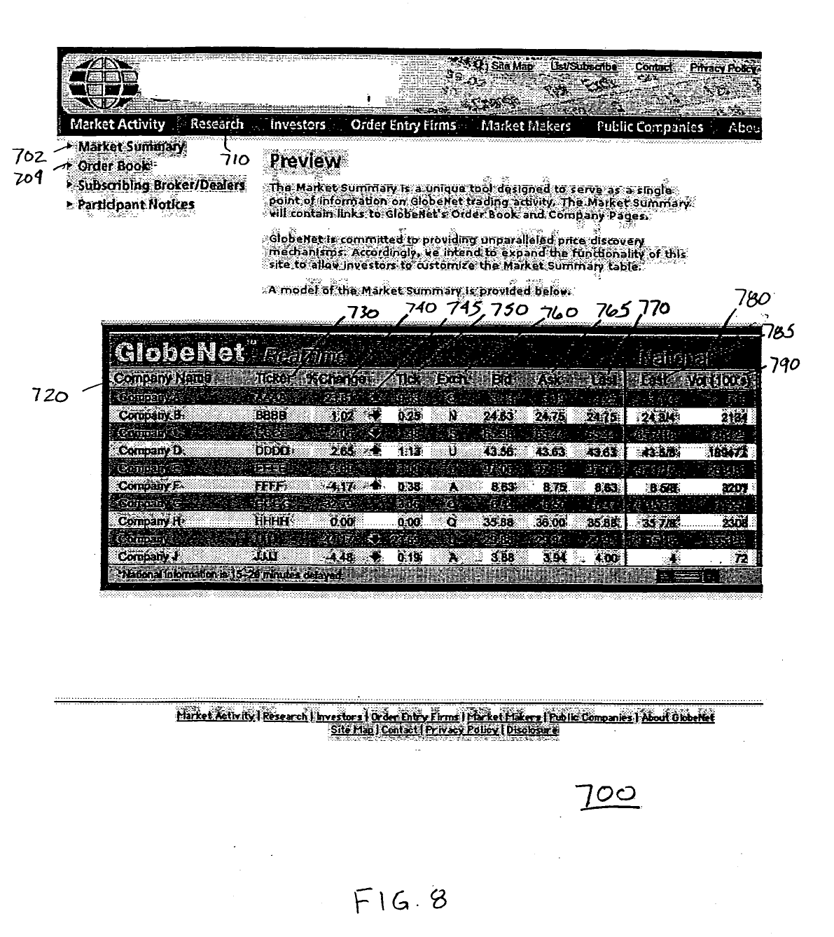

FIG. 8 depicts a Market Summary 700 screen a Subscriber may use as a unique tool to serve as a single point of information for trading activity on the system 100 described in FIGS. 1 and 2. The Market Summary 700 sill contain links to the Interactive Order Book and to Company summary pages. As seen in FIG. 7, the Subscriber can use the Market Summary link 702, the Order Book link 704 or click on the Research bar 710 for researching companies. Further, the Subscribers will be able to customize the Market Summary 700 to display Subscriber dictated information. The Market Summary 700 may contain information relating to the company name 720, the ticker or stock symbol 730, the % change 740, and tick price indicator 745, the tick (price or change since last transaction) 750, the exchange 755, the bid price 760, the ask price 765, the last price 770 and national data 780 such as the national last price 785 and the national volume 790.

The system of invention is designed to support a number of protocols governing communications with said system. The preferred embodiment of such protocols is a proprietary Application Programming Interface (API). A secondary protocol relating to securities trading is the Financial Information Exchange (FIX) protocol.

A proprietary Application Programming Interface (API) is the preferred embodiment of communications with the system. The API facilitates the integration of the systems' Graphical User Interface (GUI) or external systems, with the system of invention. The API is comprised of two parts. 1) Message definition between the System and Subscribers and 2) a software library comprised of calls a Subscriber will incorporate into their system. The API communicates with TCP/IP and can be used over a dedicated circuit or the public Internet. The API employs a Secure Socket Layer (SSL) for privacy. The SSL layer enables all communication between the Subscriber and system to be encrypted with 128-bit encryption. The TCP/IP and SSL are internal to the Library and Subscribers do not need an intimate knowledge of the Library to use the API. Messages are passed to the API as C structures. The API will place a proper header and footer for transport between the Subscriber and the System.

The API library is designed for simplicity is comprised of four (4) function calls:

OpenConnection

CloseConnection

SendMessage

RecvMessage

Open Connection

Open connection establishes a Secure Socket Layer connection with the System over a TCP IP Link. OpenConnection will return success when a connection is established. If, a connection cannot be established, the function will return a non-zero value if an error occurs.

CloseConnection

CloseConnection will close the TCP/IP link to the System. The function will return a non-zero value if an error occurs

SendMessage

SendMessage operates in blocking mode. The function will not return until there is error in the connection or the message is delivered. This function will take the given message and add a proper header and footer to the message. It then encrypts the message with 128-bit encryption before sending over the SSL layer and then over the TCP IP link.

RecvMessage

RecvMessage operates in blocking mode. The function will not return until there is error in the connection or a full message is received. This function will only return the message sent from the internal system. It is the user responsibility to have a buffer available to handle all message size to could be received. Before returning the message to the Subscriber, the message is decrypted and the header and footer are strip off.

Subscribers may choose to conform to the Financial Information eXchange (FIX) protocol. The FIX protocol is a messaging standard developed specifically for real-time electronic exchange of securities transactions. FIX is a public-domain specification owned and maintained by the FIX Organization.

The system of invention is designed to accept messages from either its accompanying Graphical User Interface (GUI) or external systems (according to a protocol). The GUI in its preferred embodiment is a browser based interface. The GUI allows Subscribers to access the system, view system information, submit messages for processing by the system, and request information on messages being processed by the system. Each Subscriber may have multiple users, each with a unique IDs and passwords required to access the system. The GUI may also take the form of a software interface or other electronic means.

The GUI in its preferred embodiment includes the following functions designed to simplify and enhance User interaction.

The color coding of buy and sell orders on the book to aid in the intuitive identification of the orders. This includes coloring of orders that are better than the nationally disseminated best buy or ask sell prices. The preferred embodiment of the color coding schema is:

| | |
|---|---|
| Green | System has the same or better price than the national best |
| Red | The national best is better than the System. |
| Black | National Market is closed |

The GUI allows individual users to customize their color scheme and includes the option to specify a color (which only that user sees) to designate their outstanding orders on the system.

Users of the GUI have the ability to “hit the book”, simply by double clicking their mouse on an order. When an order is hit, a contra-side order is sent to the system as an immediate or cancel (10C) limit order at the price listed on order to be “hit”.

The GUI includes a “cancel all orders for a security” function. The Cancel all function allows the GUI user to cancel their outstanding orders for the current Order Book's security. By clicking this button a special order type of “cancel orders” will be sent to the system and all of the user traders outstanding orders (or portions thereof) for this security will be canceled.

The GUI includes a “cancel all orders function.” The Cancel all Orders function allows the user to cancel all of their outstanding orders for the current Order Book's security. By clicking this button a special order type of “cancel all orders” will be sent to the system and all outstanding orders (or portions thereof) for this security will be canceled.

The system of the invention in its preferred embodiment further provides an interactive order book system for aggregating, manipulating, displaying and interacting with order data. In this respect, the invention provides a means on the public Internet for investors to view qualifying buy and sell orders in an electronic format. An alternative version of the Interactive order book may be offered to system Subscribers over the GUI. This version allows Subscribers to interact with the book, as described above, with a single action (such as a right click of the mouse).

In addition to conventional types of securities trading orders (e.g., market orders, limit orders, stop orders, etc.), the system of the invention in its preferred embodiment supports “match” orders and “range” orders. These novel order types are described below.

The match order is a novel type of order that augments existing methodologies of generating liquidity in otherwise illiquid markets. The system of the invention can dynamically search out the National Best Bid and Offer (NBBO) and continuously determine the decimalized mid-point of the NBBO. This can be accomplished mathematically by converting the NBBO numbers to decimalized format, if necessary; then adding the two numbers and dividing by two (2), the result being the arithmetic median. The result can then be truncated to two decimal places. The mid-point can be calculated in other manners as well, such as by calculating the arithmetic mean. The resulting number can be displayed in the Open Limit Order Book for each security registered on the system as the “Match” price at that moment in time. It is a floating number and will change in direct relationship to changes in NBBO or internal best bid or offer.

The business rules by which the system preferably makes use of the mid-point number are also unique. The “Match” Order preferably includes the variables:

Buy or Sell indication.

Number of shares to be bought or sold.

Designation of the order as a “Match” type of order.

An optional “Limit” price of the calculated “Match” price above or below which the order becomes invalid

An investor that wishes to enter a “Match” Order can click the button on the order form containing such designation. The word “Match” or “MCH” or a systematically generated price then appears in the Price window. In addition, the investor preferably must also define the “Limit” Price that may accompany the order so that the investor specifically states a price above which he will not buy or below which he will not sell.

Once a “Match” Order is entered into the system, it is placed at the top or ranked by the dynamic price within the “Limit Order Book” of the Trading System in accordance with time priority rules with other “Match” Orders on the same side of the market. A “Match” Order can be executed against another “Match” Order regardless of size, thereby allowing for partial “fills.” A “Match” Order can also be executed against a “Market” Order entered subsequent to the posting of a corresponding “Match” Order or a “Limit” order at the dynamically generated “Match” price.

Match orders preferably execute against a number of other order types. Match orders may execute against a limit order at or better than the dynamically calculated match price. In addition, match orders may execute against incoming market orders, providing price improvement for the market order.

The “Range” Order is a further novel type of order which may be provided by the system of the invention. With conventional order entry in the securities markets, the investor can only specify the maximum number of shares he is willing to sell. He has never been able to determine the minimum number of shares with the exception of two historical order types, “Fill or Kill” and “All or None,” which made the minimum number of shares to be purchased the same as the maximum number of shares. Using the “Range” Order of the invention, an investor effectively is able to communicate, as part of his order, the fact that he is willing to sell shares in minimum lot sizes up to a maximum number of shares. This order can receive partial “fills” as long as each partial “fill” or execution is in accordance with the minimum number of shares specified in the order. Therefore, a “Range” Order entered for 400-1000 shares could be “filled” in the following combinations:

One order for 1000 shares

Two orders for 500 shares

One order for 400 shares and one order for 600 shares

It should be noted that, in the preferred embodiment, a “Range” Order that receives a partial “fill” or execution and which still has sufficient shares remaining that equal or exceed that minimum size in the order will remain open for the designated duration, be it a “Day” Order or “GTC” (Good 'Til Canceled).

In the event that a “Range” Order receives a partial “fill” whereby the remaining number of shares is less than the minimum number of shares stated in the order, the order is preferably considered to be complete and the remaining shares are canceled. The Subscriber in this case will receive notification that he is “filled” on “X” number of shares and “canceled” on the remaining “X” number of shares.

Using the above example of a “Range” Order of 400-1000 shares, the following single executions may have the following results:

700 shares “filled.” Report to investor: “700 shares filled. Remaining 300 shares canceled. Order complete.”

800 shares “filled.” Report to investor: “800 shares filled. Remaining 200 shares canceled. Order complete.” This report would also be issued on the second order in the event that the 800 shares was “filled” by two 400 share executions.

900 shares “filled.” Report to investor: “900 shares filled. Remaining 100 shares canceled. Order complete.” This report would also be issued on the second order in the event that the 900 shares was “filled” by a 400 share execution plus a 500 share execution.

The system of invention is preferably designed to trade inside and outside of traditional trading hours, thereby providing Subscribers greater access to both a transaction network and pools of liquidity. The system is designed to maintain a number of “states” during the day to reflect the different environments in which it will be trading. Each state has a series of associated business rules (such as which order types it will process), each designed to preserve a fair and orderly marketplace for its Subscribers, cognizant of environmental conditions.

One of the novel aspects of the system is the means through which its orders can interact and the way such interaction provides price improvement opportunities for its Subscribers. All orders that are entered into the system can execute against one another.

First level examples of such interaction are:

| Buy Side | Sell Side |
|---|---|
| Limit | Limit |
| Limit | Match |
| Limit | Market |
| Limit | Range |
| Market | Limit |
| Market | Market |
| Market | Match |
| Market | Range |
| Match | Range |
| Match | Match |
| Match | Limit |
| Match | Market |
| Range | Match |
| Range | Limit |
| Range | Market |
| Range | Range |

It should be noted that a single order may execute against all possible combinations of orders on the contra side. This relationship creates an endless possibility of combinations that can be created as the contra side for an incoming order.

The system of invention in its preferred embodiment employs an order-matching algorithm designed to seek the best mutual matching price. This algorithm examines the prices designated within each order (for match orders this is the dynamically calculated match price, for market orders this is equivalent to the nationally disseminated best price) and then selects the mid-point of the two prices (the preferred embodiment of which is expressed and matched to four decimal places). In the event that the mid-point is not between the nationally disseminated best bid and ask prices (the NBBO), the system will look for a price at which it can match at a price equal to or better than the NBBO.

The invention preferably employs a trading system database (TSD) for use in its primary processing system (trading system). The trading system also interacts with a separate database instance that will serve as the central data repository (CDR). The CDR houses all historical information regarding trading instruments, Subscribers, and trading activity. The CDR also serves as the primary administrative database, in which all administrative changes (new trading instruments, new Subscribers, name changes, etc.) are made. The trading system interacts with the CDR at defined intervals to update its tables of trading instruments (such as securities) and qualified Subscribers. The trading system also interacts with the CDR at defined intervals to upload all trading information from the TSD into the CDR for storage and processing.

The TSD is described in detail. The TSD will be comprised of a number of tables and will, at a minimum, encompass the following four areas:

Security (or product or service or trading instrument) Information (db_stock.h)—maintaining information specific to a security (or trading instrument or product or service) and the unique trading requirements and properties thereof;

Subscriber Information (db_firm.h)—maintaining information specific to a Subscriber and the unique trading requirements thereof;

Order Information (db_order.h)—maintaining information specific to an Order and the processing thereof;

Trade Information (db_deal.h)—maintaining information specific to a match (execution) and the unique properties thereof.

Examples of each table are provided below:

DB_STOCK.H

| | | | |
|---|---|---|---|
| long | lNextRec; | /* Next available record | */ |
| short | iIndex[27]; | /* Index into table for symbol | */ |
| short | iMaxRouteQue; | /* Max route queue depth | */ |
| short | iFlushTimer; | /* Gbl flush timer, (sec) | */ |
| short | iBookTimer; | /* Book update msg timer, (sec) | */ |
| | | /* Trading times | */ |
| short | iPreopenTime; | /* Time for preopen (hhmm) | */ |
| short | iOpenTime; | /* Time to open market (hhmm) | */ |
| short | iAfterHoursTime; | /* Time for after hours (hhmm) | */ |
| short | iCloseTime; | /* Time to close market (hhmm) | */ |
| char | cMktStatus; | /* Market status | */ |
| | | /* O-Open, P-Preopen, H-Halt | */ |
| | | /* B-BeginOpen, C-Closed | */ |
| char | cExchange; | /* Exchange code | */ |
| | | /* G=GlobeNet | |

| | | | |
|---|---|---|---|
| char | cFlush; | /* DB flushed Y/N | */ |

| | | | |
|---|---|---|---|
| char | cRoute; | /* Routing on Y/N | */ |

| | | | |
|---|---|---|---|
| char | cRouteExchange; | /* Routing exchange code | */ |

} *DB_SEC_HEADER;
typedef struct sec_rec
{

| | | | |
|---|---|---|---|
| long | lFirstBid; | /* First buy order record | */ |
| long | lLastBid; | /* Last buy order record | */ |
| long | lFirstAsk; | /* First sell order record | */ |
| long | lLastAsk; | /* Last sell order record | */ |

| | | | |
|---|---|---|---|
| long | lBidPx; | /* Exchange bid price | */ |

| | | | |
|---|---|---|---|
| long | lBidSize; | /* Exchange bid size | */ |

| | | | |
|---|---|---|---|
| long | lAskPx; | /* Exchange ask price | */ |

| | | | |
|---|---|---|---|
| long | lAskSize; | /* Exchange ask size | */ |
| long | lNBidPx; | /* National bid price | */ |
| long | lNBidSize; | /* National bid size | */ |
| long | lNAskPx; | /* National bid price | */ |
| long | lNAskSize; | /* National ask size | */ |

| | | | |
|---|---|---|---|
| long | lHigh; | /* High price today | */ |

| | | | |
|---|---|---|---|
| long | lLow; | /* Low price today | */ |

| | | | |
|---|---|---|---|
| long | lVolume; | /* Volume traded today | */ |

| | | |
|---|---|---|
| long | lOpen; | /* Open/Proj open price */ |

| | | | |
|---|---|---|---|
| long | lPriorHigh; | /* Prior day high price | */ |
| long | lPriorLow; | /* Prior day low price | */ |

| | | | |
|---|---|---|---|
| long | lPriorVolume; | /* Prior day volume traded | */ |

| | | | |
|---|---|---|---|
| long | lPriorOpen; | /* Prior day open price | */ |

| | | | |
|---|---|---|---|
| long | lPriorClose; | /* Prior day close price | */ |

| | | | |
|---|---|---|---|
| long | lAverageVol; | /* Average daily volume | */ |

| | | | |
|---|---|---|---|
| long | lLastPx; | /* Last sale price | */ |

| | | | |
|---|---|---|---|
| long | lLastShares; | /* Last sale size | */ |

| | | | |
|---|---|---|---|
| long | lLastTime; | /* Last sale date/time | */ |
| long | lNLastPx; | /* External Last price | */ |

| | | | |
|---|---|---|---|
| long | lNLastShares; | /* External Last size | */ |

| | | | |
|---|---|---|---|
| long | lNLastTime; | /* External Last date/time | */ |

| | | | |
|---|---|---|---|
| long | lMaxOrdSize; | /* Max order size | */ |
| long | lMinOrdSize; | /* Min order size | */ |

| | | | |
|---|---|---|---|
| long | lHaltTime; | /* Time of halt | */ |
| short | iSpread; | /* Min price spread | */ |

| | | | |
|---|---|---|---|
| char | cBidExchange; | /* Exchange of best bid | */ |
| char | cAskExchange; | /* Exchange of best ask | */ |

| | | | |
|---|---|---|---|
| char | cMktStatus; | /* Stock status | */ |
| | | /* O-Open, C-Close, H-Halt | */ |
| | | /* S-Suspended, P-Preopen | */ |

| | | | |
|---|---|---|---|
| char | cNationlOpen; | /* External mkt open | */ |

| | |
|---|---|
| /* C-Closed, O-Open | */ |
| /* A-After Hours | */ |

| | | | |
|---|---|---|---|
| char | cTick; | /* Tick +, −, ” | */ |

| | | | |
|---|---|---|---|
| char | cPrevTick; | /* Previous Tick +, −, ” | */ |

| | | | |
|---|---|---|---|
| char | cNTick; | /* External Tick +, −, ” | */ |

| | | | |
|---|---|---|---|
| char | cPrevNTick; | /* Previous External Tick | */ |

| | | | |
|---|---|---|---|
| char | cListing; | /* Listing status | */ |

| | |
|---|---|
| /* G=GlobeNet | */ |
| /* A=Amex | */ |

| | |
|---|---|
| /* M=Chicago | */ |

| | |
|---|---|
| /* N=NYSE | */ |

| | |
|---|---|
| /* P=Pacific | */ |
| /* Q=Nasdaq NM | */ |
| /* S=Nasdaq SC | */ |
| /* U=OTCBB (US) | */ |
| /* V=OTCBB (foreign) | */ |

| | | |
|---|---|---|
| char | cBuySideHit; | /* Hit between last update */ |
| char | cSelSideHit; | /* Hit between last update */ |

| | | |
|---|---|---|
| char | sSymbol[DB_SYMBOL_LEN];/* Stock symbol | */ |

| char | sCusip[DB_CUSIP_LEN];/* Stock CUSIP | | */ |
|---|---|---|---|
| char | sFill[1]; | /* Fill to longword boundry | */ |

DB_FIRM.H

| | | | |
|---|---|---|---|
| long | lCommLink; | /* CTCI comm link number | */ |

| | | | |
|---|---|---|---|
| long | lFirmSeq; | /* Firm seq number | */ |

| | | | |
|---|---|---|---|
| long | lFirmLink; | /* Firm order link head pointer | */ |

| | | | |
|---|---|---|---|
| char | sClientID[DB_CLIENTID_LEN]; | /* FIX-109 Firm ID | */ |

| | | |
|---|---|---|
| char | sSymbol[DB_SYMBOL_LEN]; | /* FIX-55 Firm's stock symbol |

| | */ | | |
|---|---|---|---|
| char | cStatus; | /* Firm status | */ |

| | |
|---|---|
| /* A-Active, S-Suspend | */ |

| | | | |
|---|---|---|---|
| char | cOrderRouting; | /* Order routing Y/H/R/C | */ |

| | | | |
|---|---|---|---|
| char | cAfterHours; | /* After hours trading Y/N | */ |

| | | | |
|---|---|---|---|
| char | cMktMaker; | /* M-MarketMaker, B-BD | */ |
| char | cRule80A; | /* FIX-47 | */ |
| char | cQSR; | /* Y/N | */ |
| char | cAGU; | /* | */ |

| ****** Comm Stuff | | */ | |
|---|---|---|---|
| char | sLineId[DB_LINEID_LEN]; | /* CTCI line id | */ |

| | | | |
|---|---|---|---|
| char | sCommPort[DB_COMMPORT_LEN]; | /* CTCI comm port name | */ |
| char | sCommPswd[DB_COMMPSWD_LEN]; | /* CTCI comm link password | */ |

| | | | |
|---|---|---|---|
| char | cCommProtocol; | /* CTCI protocol type | */ |

| | |
|---|---|
| /* T - TCP/IP | */ |
| /* B - Bisync | */ |
| /* D - Decnet | */ |
| /* S - SNA | */ |
| /* X - X.25 | */ |

| | |
|---|---|
| /* M - MRDP | */ |
| /* F - Siac FMP | */ |

| | | | |
|---|---|---|---|
| char | cHoldIntrnl; | /* FIX-9140 1=Hold | */ |

| | | |
|---|---|---|
| sTargetTrader[10] | /* sCompID[10] | */ |

DB_ORDER.H

| | | | |
|---|---|---|---|
| long | lNextRec; | /* Next available record | */ |
| long | lDumpTime; | /* Time of last dump to disk | */ |
| long | lRejects; | /* Orders rejected | */ |
| long | lKickBack; | /* Orders returned, better NBBO | */ |

| | | | |
|---|---|---|---|
| long | lRoutes; | /* Orders routed | */ |

| | | | |
|---|---|---|---|
| long | lQuoteCount; | /* External quotes counter | */ |

| | | | |
|---|---|---|---|
| long | lLastCount; | /* External last sale count | */ |

| | | | |
|---|---|---|---|
| long | lGblDump; | /* Global dump counter | */ |

| | | | |
|---|---|---|---|
| short | iLastArchive; | /* Time archive was run (hhmm) | */ |

| | | | |
|---|---|---|---|
| char | cLastDump; | /* File ext for glb backup file | */ |

} *DB_ORDER_HEADER;typedef struct order_rec
{

| | | | |
|---|---|---|---|
| long | lFwdSecLink; | /* Forward security link (rank) | */ |

| | | | |
|---|---|---|---|
| long | lBkSecLink; | /* Back sec link pointer (rank) | */ |
| long | lFirmLink; | /* Firm link | */ |
| long | lOrderQty; | /* FIX-38 Initial volume | */ |

| | | | |
|---|---|---|---|
| long | lLeavesQty; | /* FIX-151 Volume remaining | */ |

| | | | |
|---|---|---|---|
| long | lPrice; | /* FIX-44 Scaled price | */ |

| | | | |
|---|---|---|---|
| long | lStopPx; | /* FIX-99 Stop Price | */ |

| | | | |
|---|---|---|---|
| long | lTime; | /* Entry date/time | */ |

| | | | |
|---|---|---|---|
| long | lCxlTime; | /* Order Cancel date/time | */ |
| short | iSec; | /* Security record number | */ |

| | | | |
|---|---|---|---|
| short | iFirm; | /* Firm ptr | */ |

| | | | |
|---|---|---|---|
| char | cRule80A; | /* FIX-47 | */ |
| char | cOrdStatus; | /* FIX-39 Order status | */ |

| | | | |
|---|---|---|---|
| char | cOrdType; | /* FIX-40 Order type | */ |

| | | | |
|---|---|---|---|
| char | cSide; | /* FIX-54 Side | */ |
| char | cTimeInForce; | /* FIX-59 | */ |

| | | | |
|---|---|---|---|
| char | cExecInst; | /* FIX-18 Conditions | */ |
| char | cExchange; | /* Routing Exchange | */ |

| | | | |
|---|---|---|---|
| char | cHoldIntrnl; | /* FIX-9140 1=Hold Internal | */ |

| | | | |
|---|---|---|---|
| char | cExtendedHours; | /* FIX-9133 | */ |

| char | sClOrdID[DB_CLORDID_LEN];/* FIX-11 Firm order ID | | */ |
|---|---|---|---|
| char | sFill[2]; | /* Keep it on longword boundry | */ |

DB_DEAL.H

| | | | |
|---|---|---|---|
| long | lNextRec; | /* Next free record | */ |
| long | lActAck; | /* # of Act messages sent | */ |

| | | |
|---|---|---|
| long | lActAsOfAck;/* # of Act as of msgs sent | */ |

| | | | |
|---|---|---|---|
| long | lVolume; | /* Volume traded today | */ |

} *DB_DEAL_HEADER;
typedef struct deal_rec
{

| | | | |
|---|---|---|---|
| long | lBOrd; | /* Order rec pointer (buy) | */ |
| long | lSOrd; | /* Order rec pointer (sell) | */ |

| | | | |
|---|---|---|---|
| long | lLastPx; | /* FIX-31 Price | */ |

| long | lLastShares; /* FIX-32 Volume | | */ |
|---|---|---|---|
| long | lTransactTime; | /* FIX-60 Date/Time of deal | */ |
| char | cExchange; | /* Trading Exchange | */ |

| | |
|---|---|
| /* G=GlobeNet | */ |
| /* A=Amex | */ |

| | |
|---|---|
| /* M=Chicago | */ |

| | |
|---|---|
| /* N=NYSE | */ |

| | |
|---|---|
| /* P=Pacific | */ |

| | |
|---|---|
| /* Q=Nasdaq NM | */ |
| /* S=Nasdaq SC | */ |
| /* U=OTCBB (US) | */ |
| /* V=OTCBB (foreign) | */ |

| | | |
|---|---|---|
| char | cActReported;/* Reported to ACT Y/N | */ |

| | | | |
|---|---|---|---|
| char | cCleared; | /* Cleared Y/N | */ |
| char | sFill[1]; | /* Filler | */ |

Order/Message validation in accordance with a preferred embodiment of the invention will now be discussed in detail. All incoming messages (and elements thereof) are subject to validation according to defined business logic, as it may change from time to time. Primary validation occurs on the application (trading system) level, although validation may also occur on the protocol level. A hierarchical process governs system validation. Messages that do not pass all such validation will be rejected and a rejection message returned to the appropriate Subscriber. In, its preferred environment that hierarchy is:

System Status—Is the system accepting (for processing) the message type during its current state.

Subscriber Validation—Is the Subscriber identified in the message eligible to trade on the System.

Trading Instrument ID (Symbol)—Is the product or service specified in the message eligible for trading on the system.

Security State—Is the security specified in the message currently in a state for which this message can be processed.

Order Type—Is the order type (if applicable by message type) specified in the message eligible for processing during this System state.

Volume—Does the volume specified in the message (if applicable by message type) meet the minimum standards set for processing by the System.

Price—Is a price specified in the message (if applicable by message type and order type) and if so does the price meet any specified limitations thereon.

Side—Does the message/order have a specified side (such as buy or sell, if applicable by message type) and if so are there any special restrictions places around the processing of such side.

Size—Does the message/order have a specified size limitation (such as a $ value, calculated from price x volume, if applicable by message type and side) that it must meet for processing by the System.

Time in Force (TIF)—Is the time in time in force value (if applicable by message type and system state, security state) associated with the order valid for processing by the system given its current state.

Extended-Hours—Is the order marked for trading outside of traditional trading hours, and if so is such order eligible for processing therein.

Order/Message processing in accordance with a preferred embodiment of the invention will now be discussed in detail. Order messages are processed by the system in the sequence that they are received. The system governs application level validation and all aspects of order interaction, display and matching.

Orders that comply with all application-level validations are assigned a unique sequence number. The sequence number will be provided to the Subscriber and used for tracking purposes. Validated orders are queued for processing and are available for matching. If an order is capable of execution (an acceptable contra side-party is found), a match will occur. If an order is not capable of matching, it is displayed on the Order Book or processed via Subscriber specific order instructions. Orders are matched according to a price and time priority.

The system in its preferred embodiment operates as a continuous matching system for orders entered therein. A matching cycle is precipitated, for a security, upon the following:

Receipt of a New Order

Change in Order State

Change in the NBBO or external price

Upon the occurrence of an event precipitating a matching cycle the system will:

Perform an evaluation as to where the best execution of an order can be found (price and size):

If internal go to step 2, or

If external and the order is executable (price and size), follow Subscriber specific instructions in the hold internal flag, performing one of the following:

Hold internal for processing, or

Route the order for manual processing, or

Respond to other instructions may be incorporated, or

Return the order to the Subscriber

Employ an algorithm to select countervailing parties for matching:

If contra parties found, go to step 3, or

If no parties can be found, display and rank in the book (End);

Record (update) matched trades in the database; and

Remove orders (from book) if fully executed, update size if partial fill; and

Deliver execution message to appropriate Subscriber(s); and

Deliver message for trade reporting, as appropriate; and

Repeat until no further transactions can be processed.

Order routing/return will now be described in detail. The system constantly monitors the best internal and published external prices available for its trading securities, product or service. In the event that the external primary market is open for trading, a better price (execution) is available externally, and the order is fully or partially executable (price and size), the system will take action to facilitate execution at the better price, as instructed by the Subscriber. It will either:

Hold internal for processing, or

Route the order for manual processing, or

Respond to other instructions as may be incorporated, or

Return the order to the Subscriber

Trading on the system is preferably accomplished in decimals, the preferred embodiment being four decimal places. All incoming orders priced in fractions are converted to four decimal places. Buy orders are rounded down; sell orders are rounded up. Orders may also be rounded to two decimal places for display purposes.

With respect to redundancy and recovery, the system of invention is designed to be fully redundant. In this case redundancy refers to an architecture that provides for a second process machine or means in the unlikely event that problems were to occur in a primary processing component.

Recovery refers to the fact the system of invention uses a complex schema to ensure that in the event of a problem, it will quickly be able to re-start message processing without losing a bit of information. In order to facilitate such recoverability, all incoming messages are recorded. Messages are also recorded at other processing points within the system. In the event that a problem was to occur, recorded messages for a defined period of time will be rebroadcast into the system where it will complete a pos/dup check to determine if the message had previously been processed.

System processes of the invention will now be described in detail. The system of invention includes a number of processes designed to run at defined points and perform a specific task or functionality. Such processes are required to run a marketplace. Examples of these processes are given below:

Inter-state—These processes move the trading system from one trading state to another, enacting a new set of rules.

Beginning of Day—This process prepares the trading system to begin a trading day and includes updating the Subscriber and Trading Instrument tables, as well a myriad of other functions.

End of Day—This process prepares the trading system to end a trading day and includes cancellation of all day orders, updating its trading filed to the CDR, updating Subscribrs of a daily record and a myriad of other functions.

The system of invention is further augmented by designed means of facilitating the operations and conducting surveillance therof. The preferred embodiment of both the operations and surveillance element of the System are browser-based screen providing access to real-time trading data and System interaction.

The primary functionality of the operations module of the System is to ensure that the System is working efficiently (both hardware and software), Subscribers have access to the system and all other operation issues are addresses.

The primary function of the surveillance module of the System is to identify elements of “illegal” trading activity that may occur. Examples of such activity may include “front-running,” collusion, and manipulation to ensure the orderly operation of the marketplace.

The hardware of the invention in its preferred embodiment, as previously described in reference to FIGS. 1 and 2, will now be described in more detail. The hardware and software of the system in its preferred embodiment are designed to provide a system which is secure, fast, stable and scalable. The Computer Systems preferably comprise two logical networks, the Trading Network and the Administrative Network. The two systems are interconnected but operate logically independent of one another. The Administrative Network is primarily Intel based, consisting of Microsoft NT Servers, Laser Printers, Laptops, Workstations and Thin Clients. This network also contains the necessary connectivity hardware such as: Category 5e cabling, Ethernet Switches, Patch Panels, and Modems. All equipment for this network is housed in locked cabinets in a secure room.

The Trading Network is the public portion of the computer infrastructure. The Trading Network houses the actual WEB interface to and from the trading system as well as the application and database servers. All servers and data storage areas utilize FireWall Security (CheckPoint FireWall 1) and are configured totally redundant. The platforms utilize both RAS and High Availability features. All equipment for this network is housed in locked cabinets in a secure room.

The Servers in the Trading Network are preferably SUN Microsystems servers. The WEB Servers may be parallel Enterprise 250's while the application/database server is made up of two Enterprise 4500's configured in a cluster. Such clusters have been certified by SUN Microsystems. All disk storage utilizes Raid Level 1, in addition to full disk hardware redundancy.

The Trading Network preferably utilizes some additional hardware in addition to that of the Administrative Network. The network servers utilize switched, full-duplex 100 MB inter-equipment connections. All access to and from the equipment, external and internal, is via redundant Checkpoint Fire Wall 1 firewalls. The Firewalls allow for load balancing to the WEB servers as well as port security. All servers' disk storage is backed up nightly to DLT tape libraries. A 5-week rotation is established with an offsite storage rotation.

The Administrative Network portion of the infrastructure is the vehicle that enables the carrying out of daily business functions. This network allows for Scheduling, Calendaring, Task Management, Email, Group Collaboration, Internet Browsing, Word Processing, Filing, Printing and Faxing.

All Servers in the Administrative Network may comprise, e.g., Compaq Proliant 1600r's running Microsoft Windows NT Server 4.0. All Servers are Pentium II 450 Mhz single and multiprocessor models. The Administrative Network Servers perform a variety of functions for the DNS. These functions are: Domain Authentication, Domain Backup, Email, Faxing, File and Print Services, Internet Proxy Services, Terminal Server, DHCP Services and Domain Backup Services. All of these Servers can connect directly to the “core” network Ethernet switch via gigabit Ethernet over fiber optic medium.

The workstations are preferably made up of three types of systems: laptops, thin clients and desktops. The laptops are primarily Dell Inspiron 7000's. The thin clients are the NCD ThinStar 300 model. The desktops are Compaq Desk Pro 500 Ms.

Both the Administrative Network and Trading Network can share a rack of equipment that is used to provide access to and from the Internet, the Clearing Houses and satellite offices. An additional circuit may be used to connect the CTCI interface to the NASDAQ to comply with the 90 Second Trade reporting rule. The equipment in this rack is comprised of a fiber optic multiplexor that divides the available bandwidth into usable circuits for various purposes. The fiber into the multiplexor is of OC12 capabilities (655 MB), it is split into a burstable T3 (45 MB) for the WEB Servers, Fraction T1's (1.54 MB) for the Clearing Houses and the remote offices, and Voice T1's (48 channels) for the telephone switch. The fiber optic access is a spur directly off of an MCI Fiber Backbone loop (SONET RING).

The interface for the Interactive Order Book of the invention will now be described in detail. In this respect, the invention provides a system and method for aggregating, manipulating and displaying order data. In particular, the invention provides a novel process by which retail investors or other users view qualifying offers to buy and sell securities in an electronic format. The system and method of the present embodiment preferably operates in conjunction with the trading system described above and preferably provides access to an interactive order book via the Internet or the GUI such as that described above. However, it will be understood by those skilled in the art that the interactive order book as described below can be used with other securities trading systems and can use networks other than the Internet without departing from the spirit and scope of the invention.

The process provides for filtering of internal customer order data and selection of qualifying data for placement on a display mechanism (order book). Order data may include the following elements (in any order), ticker symbol (or other identifier), price (optional), size (quantity), time and date stamp, indication of either buy or sell, any limitations placed thereon and a unique order identifier. Upon submission, the order data is combined with data regarding the identity of the entering party and other related underlying data (such as account information) to create a unique data set. The process evaluates all entered elements and displays identified qualifying data items.

Data which qualifies for inclusion in the interactive order book display specifically includes “open” orders, which comprise both priced and unpriced orders (that have yet to receive execution against a contra order or routing to an alternative destination.

The system and method of the invention in accordance with the present embodiment provides investors with a means to view order data in a real-time, intuitive and openly disseminated manner. The system and method of the invention in accordance with the present embodiment provides Subscribers with a means to view, interact and disseminate order data in a real-time, intuitive and openly disseminated manner. It facilitates a new level of interaction with the user, which is set forth in further detail below. For years such data has been the sole province of professional traders. Even the language that is used to represent buy and sell orders, “bid” and “ask,” respectively, originates from a dealer-style market. The data is made available on a closed network, traditionally available only to brokers. A great deal of effort has been and continues to be made to keep such information from the average investor. Only recently has order data been made available to retail investors, and this is to a select group of “active traders” or wealthy individuals. Such groups are not provided the data in a manner that suits their needs, rather, they are simply provided read-only access to the tools and software of a professional trader.

An example of a display mechanism in accordance with the invention is shown in FIG. 3. The display mechanism is preferably color-coded and easily read. It may be designed to combine internal and external order elements. That is, the display preferably provides the investor with both internal order data (order data from the trading system referred-to above) and external order data (data from orders originating in other external sources such as stock exchange systems, or NASDAQ). The invention provides the investor with an improved tool for price discovery (transparency), price improvement and best execution methods.

As set forth in detail above, the system of the invention in its preferred embodiment allows Subscriber to enter orders for processing by the system The underlying elements of certain unexecuted orders will qualify for display in the order book display of the invention. This display can be made available (in different iterations) over the internet and via the GIUI. Upon execution, order data is preferably removed from the order book and no longer qualifies for display. The order book may integrate qualifying orders entered into the system with national best price (prices) for both the buy (ask) and sell (bid) data or other external data.

Within each book, data is ranked according to the following criteria:

1) Price—the price of an order

2) Time—the time at which data was entered

3) Size—the specified quantity

It should be noted that Match orders are unpriced and will be given priority based upon the existing match price (defined below). Depending upon the situation and primary market of the trading element, market orders may also be permitted to “hit” the book. In such instance they will be given priority based upon a means to be determined by the system Administrator. Such a means shall include external best, internal best, last sale or another price as determined by the system Administrator.

The display mechanism can take several forms as depicted in FIGS. 3-8. The display mechanism is security (or product or service) specific and may contain the following elements:

Company Name—name of the company issuing the trading element (or manufacturing, distributing the trading element)

Symbol—Unique identifier of the element about which data is being collected and displayed

Price—Price $ at which trading will occur

Size—quantity that one wishes to buy or sell

Limitation Identifier—symbol alerting user that some (specified or unspecified) limitation was been issued in connection therewith

National Best Buy (Ask or Offer)—the best (least expensive) widely disseminated price at which to buy the trading item.

National Best Sell (Bid)—the best (most expensive) widely disseminated price at which to sell the trading item

Match price—the mid point of the bid and ask price as determined by the arithmetic median of the National Best Buy and National Best Sell Prices. Note this can also be calculated by the arithmetic mean.

Unique Identifier—the unique identifier is one that is either order or account specific and will allow the user to track their order throughout the system.

The display mechanism is preferably delineated into two sides, the buy side (Bid) and the sell side (Ask), with the sell side located on the right and the buy side located on the left. FIGS. 3 and 4 illustrate several alternative general formats for the display. In FIG. 3, data from qualifying orders are displayed with size and price shown on the buy side and price and size shown on the sell side. Additional data elements, such as a time associated with each displayed order or an identifier, can be included. Further, as illustrated in FIGS. 3 and 4, data rows on the buy side are preferably ranked in descending order according to 1) price, 2) time, 3) size. As illustrated in FIGS. 3 and 4, data rows on the sell side are ranked in ascending order according to 1) price, 2) time, 3) size.

National (external) buy and sell prices can be included in the display in a number of ways. National best prices can be assigned a unique identifier such as a color or number. In FIGS. 3-8, national best prices could be identified by being displayed in red, but it will be understood that other colors and means for identification of national best prices can be used without departing from the spirit and scope of the invention.

As illustrated in FIGS. 3-8, national best prices may be included in a separate designated row in the order book. National best prices may be included (just as any other order would be) in the book. In this manner they are simply given priority, as any other order would be according to price, time, size. Multiple national prices (widely disseminated) may be included in their own display mechanism next to the system display mechanism

A further feature of the invention is the interactivity that the user is afforded though presentation on the internet. The system of the invention can allow trading participants, through either a sponsoring broker or designated broker participants, to enter orders directly to the system. Participants may track their order if it is posted to the display mechanism. Participants may track their order via a unique color and/or identifier. For example, the color green may be used to identify a trading participant's own order and the color yellow may be used to identify Match orders.

In addition to entering and tracking their orders, trading participants can also amend or delete their orders prior to execution. Any changes will be immediately reflected in the display mechanism, except that there may be a slight delay incorporated in order to preserve order fulfillment integrity if regulatory rules so require. Trading participants can also identify contra orders that they would like to trade against, submit the order (data), and watch as the identified order is adjusted or removed from the display mechanism.

It should be noted that cloaking may be used in connection with the display of this invention. Cloaking allows the user to choose to cloak a displayed item. A cloaked item will appear in a form such as [XXXX} that will prohibit anyone viewing the display from knowing the actual value or identifier thereunder. The system administrator will maintain, at its sole discretion, authority over what elements may be cloaked and when they may be cloaked.

As a means of increasing interaction with the invention, it may be presented in a way such that an item in the display of each order will be a hyperlink. The hyperlink will bring up an order form. The order form will be pre-filled with the price and size information of the order so chosen. This means will create a new level of interactivity between the invention and the user.

While the invention has been particularly shown and described with reference to a preferred embodiment thereof, it will be understood by those skilled in the art that various changes in form and details may be made therein without departing from the spirit and scope of the invention.

The embodiments of the invention in which an exclusive property or privilege is claimed are defined as follows:

1. An automated securities trading system for displaying an interactive open order book and for matching buyer bids to seller offers, comprising:
means for generating a web page which displays an open order book to a securities buyer or securities seller, said open order book comprising data describing a plurality of current bid prices and a plurality of current ask prices of a specified security and an identification of said security.

2. The automated securities trading system according to claim 1, wherein said web page includes an identification of a best bid price and an identification of a best ask price.

3. The automated securities trading system according to claim 2, wherein said identification comprises color coding of said best bid price and said best ask price to distinguish them from other bid and ask prices in said plurality of current bid and ask prices.

4. The automated securities trading system according to claim 24, wherein said identification of said security comprises a ticker symbol.

5. The securities trading system according to claim 24, wherein said means for generating a web page which displays an open order book allows said buyer or seller to aggregate a plurality of buy and sell data.

6. The securities trading system according to claim 1, wherein said means for generating a web page which displays an open order book allows said buyer or seller to manipulate a plurality of buy and sell data.

7. The securities trading system according to claim 1, wherein said means for generating a web page which displays an open order book allows said buyer or seller to interact with a plurality of buy and sell data.
